(19) United States
(12) Patent Application Publication
(10) Pub. No.: US 2026/0061600 A1
(43) Pub. Date: Mar. 5, 2026

(54) CONTROL DEVICE FOR A ROTATING CYLINDER USING MULTIPLE BEVELED WHEELS

(71) Applicant: KOREA ATOMIC ENERGY RESEARCH INSTITUTE, Daejeon (KR)

(72) Inventors: Sang Jin CHO, Daejeon (KR); Jong Yul Kim, Daegu (KR)

(73) Assignee: KOREA ATOMIC ENERGY RESEARCH INSTITUTE, Daejeon (KR)

(21) Appl. No.: 19/309,816

(22) Filed: Aug. 26, 2025

(30) Foreign Application Priority Data
Sep. 3, 2024 (KR) 10-2024-0119593

(51) Int. Cl. B25J 9/12; B25J 9/06

(52) U.S. Cl. CPC B25J 9/126; B25J 9/065

(57) ABSTRACT

The present disclosure provides a control device for a rotating cylinder that may align horizontality or precisely control a target angle using six obliquely cut wheels, and at the same time, adjust a height and a position of a rotation axis. In an embodiment, the control device for a rotating cylinder includes a first rotary unit including a first wheel and a second wheel; a second rotary unit connected to the first rotary unit and including a third wheel and a fourth wheel; and a third rotary unit including a fifth wheel and a sixth wheel; a driving unit independently driving the first to sixth wheels; a memory storing commands; and a processor rotating at least one wheel among the first to sixth wheels by executing the commands, to control the driving unit such that an inclination angle of the rotating cylinder is adjusted to a preset target value.

### CROSS-REFERENCE TO RELATED APPLICATION(S)

This application claims benefit of priority to Korean Patent Application No. 10-2024-0119593 filed on Sep. 3, 2024 in the Korean Intellectual Property Office, the disclosure of which is incorporated herein by reference in its entirety.

### BACKGROUND

### 1. Field

The present disclosure relates to a control device for a rotating cylinder that may align horizontality or precisely control a target angle using six obliquely cut (beveled) wheels, and at the same time, adjust a height and a position of a rotation axis.

### 2. Description of Related Art

Precise parallelism alignment and horizontality maintenance in manufacturing equipment for advanced fields and industrial applications may be key factors in quality and yield of products. In order to conventionally align parallelism, since balls at four corners (or three-point support) may be pushed up and a height may be adjusted repeatedly by measuring and adjusting height, there may be a disadvantage of requiring a large amount of time. In addition, although parallelism alignment may be easy in a two-axis goniometer, there may be a disadvantage in that the goniometer cannot be used for alignment of high-load machines or equipment because the goniometer may be used for relatively light equipment.

Patent Document 1 discloses a robotic mechanism with two degrees of freedom to implement movement of an invertebrate such as a snake by independently rotating two rotary plates. Meanwhile, Patent Document 1 discloses that it may be possible to implement snake-like movement using tilt control or a conical motion using a robotic mechanism formed of two rotary plates, but fails to present a specific method for movement of center coordinates or a change in the height of the rotary plates.

(Patent Document 1) US 2015-0047452 A1

### SUMMARY

The present disclosure is intended to solve the problems outlined hereinbefore, and is to provide a control device for a rotating cylinder that may align horizontality or precisely control a target angle using six obliquely cut (beveled) wheels, and at the same time, adjust a height and a position of a rotation axis.

In order to achieve the purpose, the present disclosure may provide the following control device for a rotating cylinder.

In an embodiment, the present disclosure includes a control device for a rotating cylinder including a first rotary unit including a first wheel and a second wheel, of which inclined surfaces having a deflection angle based on each of base surfaces are disposed to contact each other; a second rotary unit connected to the first rotary unit and including a third wheel and a fourth wheel, of which inclined surfaces having a deflection angle based on each of base surfaces are disposed to contact each other; and a third rotary unit including a fifth wheel and a sixth wheel, of which inclined surfaces having a deflection angle based on each of base surfaces are disposed to contact each other, wherein the first to sixth wheels are disposed in sequence in one direction; a driving unit independently driving the first to sixth wheels; a memory storing a command performing an operation; and a processor connected to the memory and the driving unit to execute the command, wherein the operation rotates at least one wheel among the first to sixth wheels to control the driving unit such that an inclination angle of the rotating cylinder, an inclination angle of the base surface of the sixth wheel with respect to the base surface of the first wheel, or a position of the base surface of the sixth wheel with respect to the base surface of the first wheel is adjusted to a preset target value.

In an embodiment, in the rotating cylinder, the first to sixth wheels may be disposed in sequence in one direction, wherein the second and third wheels may be disposed such that the base surfaces thereof are adjacent and parallel to each other, and the fourth and fifth wheels may be disposed such that the base surfaces thereof are adjacent and parallel to each other, and wherein the first and second wheels may have the same first rotation center and may be disposed to be rotatable relative to each other, the third and fourth wheels may have the same second rotation center and may be disposed to be rotatable relative to each other, and the fifth and sixth wheels may have the same third rotation center and may be disposed to be rotatable relative to each other.

In an embodiment, the operation may control the driving unit to correct the inclination angle of the rotating cylinder, and, while maintaining the adjusted inclination angle of the rotating cylinder, may rotate a plurality of wheels among the first to sixth wheels to correct a coordinate among an X-coordinate, a Y-coordinate, or a Z-coordinate of a second reference point of the rotating cylinder in which rotation axes of the fifth and sixth wheels intersect.

In an embodiment, in a process of correcting a coordinate among the X-coordinate, the Y-coordinate, or the Z-coordinate of the second reference point, the operation may include rotating at least one of the first to sixth wheels, to re-correct a changed coordinate in changing one of remaining coordinates to an initial position.

In an embodiment, after performing a mathematical calculation of correcting a coordinate among the X-coordinate, the Y-coordinate, or the Z-coordinate of the second reference point, the operation may include performing a mathematical calculation of correcting a first remaining coordinate thereamong, and then performing a mathematical calculation of correcting a second remaining coordinate thereamong.

### BRIEF DESCRIPTION OF DRAWINGS

The and other aspects, features, and advantages of the present disclosure will be more clearly understood from the following detailed description, taken in conjunction with the accompanying drawings, in which:

FIGS. 1 and 2 are plan views of a rotating cylinder formed of two wheels, when viewed in a second direction.

FIG. 3 is a schematic perspective view of a rotating cylinder formed of two wheels.

FIGS. 4A and 4B are views illustrating changes in inclination angle of the rotating cylinder, depending on rotation of the wheels in FIG. 3.

FIGS. 5A and 5B are schematic plan views illustrating changes in an orthogonal coordinate system, depending on rotation of a first wheel or a second wheel, when viewed in a first direction.

FIG. 6 is a schematic plan view of a control device for a rotating cylinder according to an embodiment of the present disclosure.

FIG. 7 is a block diagram of a computing device that may entirely or partially implement a control device for a rotating cylinder according to an embodiment of the present disclosure.

FIGS. 8A, 8B, 9A, and 9B schematically illustrate usage status diagrams of a control device for a rotating cylinder according to an embodiment of the present disclosure.

FIG. 10 is a schematic plan view of a control device for a rotating cylinder according to another embodiment of the present disclosure.

FIGS. 11 and 12 schematically illustrate usage status diagrams of a control device for a rotating cylinder according to another embodiment of the present disclosure.

### DETAILED DESCRIPTION

Hereinafter, specific embodiments of the present disclosure will be described with reference to the attached drawings. However, the idea of the present disclosure is not limited to the presented embodiments, and those skilled in the art who understand the idea of the present disclosure may easily propose other backward inventions or other embodiments included within the scope of the idea of the present disclosure by adding, changing, or deleting other components within the scope of the same idea, but this may be also included within the scope of the idea of the present disclosure.

In addition, throughout the specification, the term “connected” to another component means not only a case in which these components are “directly connected” to each other but also a case in which these components are “indirectly connected” to each other with another component interposed therebetween. In addition, “comprising” or “including” a component means that other components may be included rather than excluding other components, unless specifically stated otherwise.

In addition, components with the same function within the scope of the same idea illustrated in the drawings of each embodiment may be described using the same reference numerals.

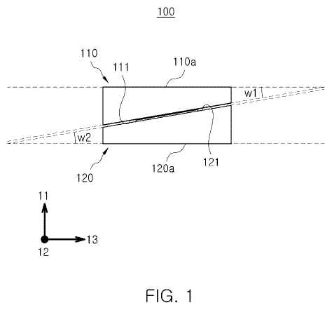

A control device for a rotating cylinder according to an embodiment of the present disclosure and a flatness control method using the same may control the flatness of a rotating cylinder formed of three wheels. Before explaining the control device and the control method for a rotating cylinder according to an embodiment of the present disclosure, a control method of a rotating cylinder formed of two wheels will first be explained with reference to FIGS. 1 to 5. In addition, a control method of a rotating cylinder described with reference to FIGS. 1 to 5 may be supported by a specification of KR 10-2024-0054461 filed by the applicant of the present disclosure.

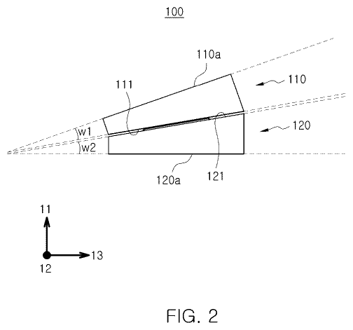

FIGS. 1 and 2 are views illustrating a rotating cylinder formed of two wheels.

More specifically, FIGS. 1 and 2 are plan views of a rotating cylinder 100 formed of two wheels, when viewed in a second direction, and more specifically, are plan views of a rotating cylinder 100 in which a deflection angle of a first wheel 110 and a deflection angle of a second wheel 120 are equal, when viewed in the second direction.

In the specification of the present disclosure, the rotating cylinder 100 may mean a rotating cylinder cut obliquely and including two rotating wheels. Furthermore, in the specification of the present disclosure, a first direction 11 may mean a height direction in the drawings and a direction in which the first wheel 110 and the second wheel 120 are stacked, and a second direction 12 and a third direction 13 may mean directions, perpendicular to the first direction 11, and directions, parallel to a horizontal plane, and the second direction 12 and the third direction 13 may be directions, perpendicular to each other.

The rotating cylinder 100 may include the first wheel 110 and the second wheel 120, each of which has an inclined surface (111 and 121) formed at a deflection angle (w) relative to the horizontal plane. In this case, the first wheel 110 and the second wheel 120 may be disposed such that the respective inclined surfaces 111 and 121 thereof may be in contact with each other, and may have a shape in which inclined surfaces of a cylinder are disposed to face each other. The inclined surface 111 of the first wheel 110 may form a first deflection angle w1 with a first base surface 110a of the first wheel 110, and the inclined surface 121 of the second wheel 120 may form a second deflection angle w2 with a second base surface 120a of the second wheel 120. In this case, the first wheel 110 and the second wheel 120 may rotate independently, and a rotation center of the first wheel 110 and a rotation center of the second wheel 120 may be provided to be the same. For example, the first wheel 110 and the second wheel 120 may have rotation axes 110c and 120c, perpendicular to the respective base surfaces 110a and 120a thereof, and a first rotation axis 110c of the first wheel 110 and a second rotation axis 120c of the second wheel 120 may be provided to face the same rotation center. In this case, a rotation angle may be defined based on a phase of the first wheel 110 in the present specification, for example, a rotation angle of the first wheel 110 may be 0°, and a rotation angle of the second wheel 120 may be an angle to be rotated based on the first wheel 110, for example, 180°.

As illustrated in FIGS. 1 and 2, the first deflection angle w1 and the second deflection angle w2 may be equal to each other. In this case, when the rotating cylinder 100 is in equilibrium, the first base surface 110a and the second base surface 120a may be parallel to each other, and may be aligned to be parallel to the horizontal plane, thereby enabling horizontal alignment.

As illustrated in FIG. 1, the rotating cylinder 100 may be provided such that, when viewed in the second direction, one end portion of the first wheel 110 is located on one side of the third direction, and one end portion of the second wheel 120 is located on the other side in the third direction. In the specification of the present disclosure, a reference position of the first wheel 110 may be set such that one end portion is located on one side of the third direction, and in this case, a phase of the first wheel 110 may be set to 0°. Conversely, a reference position of the second wheel 120 may be set such that one end portion located to oppose one end portion of the first wheel 110 is located on the other side of the third direction, and in this case, a phase of the second wheel 120 may be set to 180°. For example, when a phase difference between the first wheel 110 and the second wheel 120 is 180°, the rotating cylinder 100 may be horizontally aligned, and as illustrated in FIG. 2, when the phase difference between the first wheel 110 and the second wheel 120 is 0°, the rotating cylinder 100 may have an inclination angle, equal to a sum of the first deflection angle w1 and the second deflection angle w2.

For example, the rotating cylinder 100 formed of two wheels having the deflection angle w may align flatness using a change value of the inclination angle of the first base surface 110a to be changed, depending on rotation of the first wheel 110 and rotation of the second wheel 120, and may be applied equally to cases in which the first deflection angle w1 and the second deflection angle w2 are the same and different.

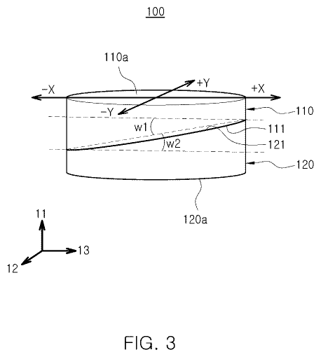

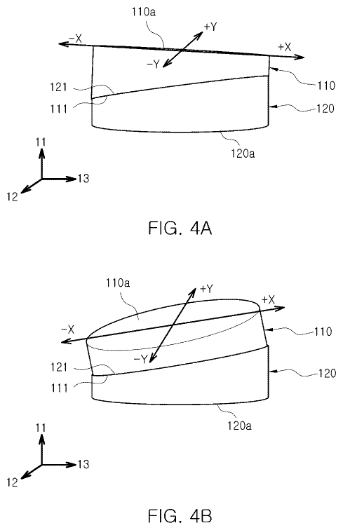

FIG. 3 and FIGS. 4A and 4B are views illustrating changes in inclination angle of a rotating cylinder 100 according to rotation of one of two wheels, as described in FIGS. 1 and 2. More specifically, FIG. 3 is a schematic perspective view of a rotating cylinder formed of two wheels, and FIGS. 4A and 4B illustrate changes in inclination angle of the rotating cylinder, depending on rotation of the wheels in FIG. 3.

A control method of a rotating cylinder may include a first wheel 110 and a second wheel 120, in which an inclined surface (111 and 121) is formed at a deflection angle (w1 and w2) based on a base surface (110a and 120a), and may control a rotating cylinder 100 disposed such that the inclined surface 111 of the first wheel 110 and the inclined surface 121 of the second wheel 120 are in contact, and more specifically, may change an inclination angle of the rotating cylinder 100, depending on rotation of the first wheel 110 and rotation of the second wheel 120.

In this case, the rotating cylinder 100 may set a virtual orthogonal coordinate system, and in the specification of the present disclosure, a change in inclination angle may mean a change in an orthogonal coordinate system. More specifically, the virtual orthogonal coordinate system may be set on the base surface 110a of the first wheel 110 or on the first base plate 131, and change values of an X-axis inclination angle and a Y-axis inclination angle of the rotating cylinder 100 may mean change values of an X-axis and a Y-axis of the virtual orthogonal coordinate system in the first direction 11.

In this case, the control method of a rotating cylinder may rotate the first wheel 110 and the second wheel 120 by a first rotation angle θ₁ and a second rotation angle θ₂, respectively, to change to have an X-axis inclination angle and a Y-axis inclination angle of the rotating cylinder 100 to be targeted, and may be applied even when a rotation direction of the first wheel 110 and a rotation direction of the second wheel 120 are different from each other. The following description may be based on the assumption that the rotation direction of the first wheel 110 and the rotation direction of the second wheel 120 are the same.

FIG. 4A is a schematic perspective view illustrating a state in which a second wheel 120 rotates 10° clockwise in a rotating cylinder 100 according to an embodiment of the present disclosure, and FIG. 4B is a schematic perspective view illustrating a state in which a first wheel 110 rotates 10° clockwise in a rotating cylinder 100 according to an embodiment of the present disclosure.

As illustrated in FIG. 4A, when the second wheel 120 rotates 10° clockwise, an X-axis inclination angle and a Y-axis inclination angle of the rotating cylinder 100 may have a (−) inclination angle with respect to the third direction 13. As illustrated in FIG. 4B, when the first wheel 110 rotates 10° clockwise, the X-axis and Y-axis inclination angles of the rotating cylinder 100 may have a (+) inclination angle with respect to the third direction 13.

For example, as the first wheel 110 or the second wheel 120 rotates clockwise, the X-axis and Y-axis inclination angles of the rotating cylinder 100 may change to (−) or (+) with respect to the third direction 13. In the rotating cylinder 100 according to an embodiment of the present disclosure, when the first wheel 110 and the second wheel 120 rotate in the same direction by the same angle, the X-axis and Y-axis inclination angles of the rotating cylinder 100 may be the same as an initial state. For example, in a horizontally aligned state as illustrated in FIG. 3, when the first wheel 110 and the second wheel 120 rotate in the clockwise direction by the same angle, the rotating cylinder may return to the horizontally aligned state.

In this case, the control method of a rotating cylinder may apply a relationship between a change value C1 of the X-axis inclination angle of the rotating cylinder 100 and a change value C2 of the Y-axis inclination angle of the rotating cylinder 100 to a trigonometric function. More specifically, since the X-axis and the Y-axis have a difference of 90°, the change value C1 of the X-axis inclination angle may apply a cosine function to the deflection angle w1 of the first wheel 110, and the change value C2 of the Y-axis inclination angle may apply a sine function to the deflection angle w2 of the second wheel 120.

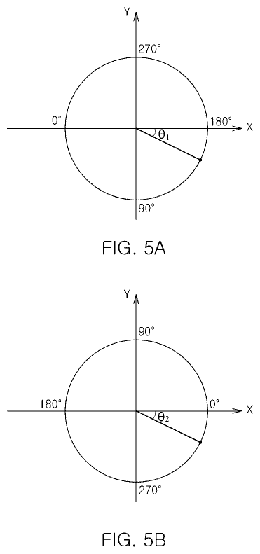

FIGS. 5A and 5B are schematic plan views illustrating changes in an orthogonal coordinate system, depending on rotation of a first wheel 110 or a second wheel 120, when viewed in a first direction. More specifically, FIG. 5A is a schematic plan view illustrating movement of coordinates when the first wheel 110 rotates clockwise by θ₁, and FIG. 5B is a schematic plan view illustrating movement of coordinates when the second wheel 120 rotates clockwise by θ₂. In this case, the first wheel 110 and the second wheel 120 may be explained based on the assumption that they have a phase difference of 180°.

When the first wheel 110 rotates counterclockwise by θ₁, an X-axis inclination angle after rotation may be expressed as w1 cos θ₁, and a Y-axis inclination angle after rotation may be expressed as w1 sin θ₁. When the first wheel 110 rotates counterclockwise by θ₁, θ₁ may have a value between 90° and 180° based on a phase of the first wheel 110, so cos θ₁ may have a (+) value. In reality, when the first wheel 110 rotates clockwise by θ₁, change values of the X-axis and Y-axis inclination angles of the rotating cylinder should have a (+) value, so the change value of the X-axis inclination angle may be expressed as w1 (+cos θ₁).

Similarly, as illustrated in FIG. 5B, in a state in which the first wheel 110 is fixed, when the second wheel 120 rotates clockwise by θ₂, the X-axis and Y-axis may also rotate counterclockwise by θ₂.

In this case, a change value C1 of the X-axis inclination angle of the rotating cylinder 100 may be calculated as a sum of the change values of the X-axis inclination angles of each of the first wheel 110 and the second wheel 120, and a change value C2 of the Y-axis inclination angle of the rotating cylinder 100 may be calculated as a sum of the change values of the Y-axis inclination angles of each of the first wheel 110 and the second wheel 120. For example, the change value C1 of the X-axis inclination angle of the rotating cylinder 100 may be ω1·cos θ₁+ω2 cos θ₂, and the change value C2 of the Y-axis inclination angle of the rotating cylinder may be ω1·sin θ₁+ω2·sin θ₂.

Therefore, a first rotation angle θ₁ and a second rotation angle θ₂ according to the change value C1 of the X-axis inclination angle and the change value C2 of the Y-axis inclination angle of the rotating cylinder may be calculated by the following mathematical formulas a and b.

$$C 1 = ω1 \cdot cos {⊖}_{1} + ω2 \cdot cos {⊖}_{2} \qquad Mathematical Formula a$$

$$C 2 = ω1 \cdot sin {θ}_{1} + ω2 \cdot sin {θ}_{2} \qquad Mathematical Formula b$$

In this case, θ₁ is a first rotation angle, θ₂ is a second rotation angle, w1 is a deflection angle of the first wheel, w2 is a deflection angle of the second wheel, C1 is a change value of an X-axis inclination angle, and C2 is a change value of a Y-axis inclination angle.

In this case, when the deflection angles w1 and w2 are equal to each other, the first rotation angle θ₁ and the second rotation angle θ₂ may have one solution, and when the deflection angles w1 and w2 are different from each other, the first rotation angle θ₁ and the second rotation angle θ₂ may have two pairs of solutions.

Mathematical formulas a and b above may be applied when a positive direction of the X-axis, 0°, is set as a reference axis of a phase of the first wheel 110, as in FIG. 5A, and when the second wheel 120 has a phase difference of 180° from the first wheel 110, as in FIG. 5B. On the contrary, when the positive direction of the X-axis, 0°, is set as a reference axis of a phase of the second wheel 120, and the first wheel 110 has a phase difference of 180° from the second wheel 120, the first rotation angle θ₁ and the second rotation angle θ₂ may be calculated by the following mathematical formulas a-1 and b-1.

$$C 1 = ω1 \cdot cos {θ}_{1} + ω2 \cdot cos {θ}_{2} \qquad Mathematical Formula a - 1$$

$$C 2 = ω1 \cdot sin {θ}_{1} + ω2 \cdot sin {θ}_{2} \qquad Mathematical Formula b - 1$$

In this case, θ₁ is a first rotation angle, θ₂ is a second rotation angle, ω1 is a deflection angle of the first wheel, ω2 is a deflection angle of the second wheel, C1 is a change value of an X-axis inclination angle, C2 is a change value of a Y-axis inclination angle. This is nothing more than a change in sign depending on setting of the reference position.

Using the mathematical formulas a and b, a range of the change value C1 of the X-axis inclination angle and a range of the change value C2 of the Y-axis inclination angle of the rotating cylinder may be calculated by the first deflection angle w1 and the second deflection angle w2. More specifically, when the mathematical formulas a and b may be squared and added, C1²+C2² may be expressed by the mathematical formula c below.

$$C {1}^{2} + C {2}^{2} = {ω1}^{2} + {ω2}^{2} + 2 ω1ω2 \cdot cos ( {θ}_{1} - {θ}_{2} ) \qquad Mathematical Formula c$$

In this case, θ₁ is a first rotation angle, θ₂ is a second rotation angle, w1 is a deflection angle of the first wheel, w2 is a deflection angle of the second wheel, C1 is a change value of an X-axis inclination angle, and C2 is a change value of a Y-axis inclination angle.

In this case, since a value of cos(θ₁−θ₂) may be determined from −1 to +1, a range of the change value C1 of the X-axis inclination angle and a range of the change value C2 of the Y-axis inclination angle of the rotating cylinder may be calculated by the mathematical formula d below.

$${( ω1 - ω2 )}^{2} \leq C {1}^{2} + C {2}^{2} \leq {( ω1 + ω2 )}^{2} \qquad Mathematical Formula ( d )$$

In this case, w1 is a deflection angle of the first wheel, w2 is a deflection angle of the second wheel, C1 is a change value of an X-axis inclination angle, and C2 is a change value of a Y-axis inclination angle.

For example, when the first deflection angle w1 of the first wheel 110 is 5°, the second deflection angle w2 of the second wheel 120 is 10°, and a target change value of the Y-axis inclination angle of the rotating cylinder 100 is 0°, a range of a target change value of the X-axis inclination angle of the rotating cylinder 100 may be 5° to 15°.

For example, the control method of a rotating cylinder formed of two wheels may align horizontality or may control to have a target inclination angle by rotation of at least one of the first wheel 110 or the second wheel 120, but as described above, a range of a change value of an inclination angle may be limited to a value calculated by the mathematical formula c, depending on the deflection angle w1 and w2. In addition, the rotating cylinder 100 formed of two wheels may have a disadvantage in that a height, which may be a distance in the first direction 11 from a ground to a coordinate center of the first wheel 110, cannot be adjusted.

The present disclosure recognizes the problems, and provides a control device for a rotating cylinder that may align horizontality or precisely control a target angle using six obliquely cut (beveled) wheels, and at the same time, adjust a height and a position of a rotation axis, and a flatness control method using the same.

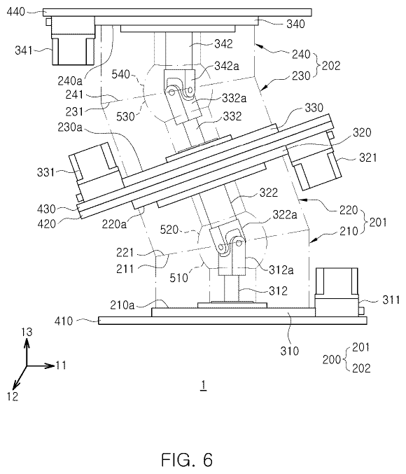

FIG. 6 is a schematic plan view of a control device 1 for a rotating cylinder according to an embodiment of the present disclosure.

A control device 1 for a rotating cylinder according to an embodiment of the present disclosure may include a rotating cylinder 200 including a first rotary unit 201 and a second rotary unit 202. The first rotary unit 201 may include a first wheel 210 and a second wheel 220, having deflection angles w1 and w2, and the second rotary unit 202 may include a third wheel 230 and a fourth wheel 240, having deflection angles w3 and w4. In addition, the control device 1 for a rotating cylinder according to an embodiment of the present disclosure may include a driving unit 300 for independently driving the first to fourth wheels 210, 220, 230, and 240, a base unit 400, and a support unit 500.

The first to fourth wheels 210, 220, 230, and 240 may be disposed in sequence from a ground. In this case, the first wheel 210 may be formed such that a first base surface 210a and a first inclined surface 211 forming a first deflection angle w1 based on the first base surface 210a are opposed to each other, and the second wheel 220 may be formed such that a second base surface 220a and a second inclined surface 221 forming a second deflection angle w2 based on the second base surface 220a are opposed to each other, and the first wheel 210 and the second wheel 220 may be disposed such that the first and second inclined surfaces 211 and 221 are in contact with each other. Likewise, the third wheel 230 may be formed such that a third base surface 230a and a third inclined surface 231 forming a third deflection angle w3 based on the third base surface 230a are opposed to each other, and the fourth wheel 240 may be formed such that a fourth base surface 240a and a fourth inclined surface 241 forming a fourth deflection angle w4 based on the fourth base surface 240a are opposed to each other, and the third wheel 230 and the fourth wheel 240 may be disposed such that the third and fourth inclined surfaces 231 and 241 are in contact with each other.

The first rotary unit 201 and the second rotary unit 202 may be provided to be connected to each other. More specifically, the second wheel 220 and the third wheel 230 may be provided such that the second and third base surfaces 220a and 230a are in contact with each other, and the first wheel 210 and the second wheel 220 may be disposed to be rotatably disposed with respect to each other, with the same first rotation center RC1 on the first and second inclined surfaces 211 and 221, and the third wheel 230 and the fourth wheel 240 may be disposed to be rotatably disposed, with the same second rotation center RC2 on the third and fourth inclined surfaces 231 and 241. In the specification of the present disclosure, a meaning of being disposed in contact with each other may not only mean a case in which surfaces are in direct contact with each other, but may also mean a case in which surfaces are not in direct contact but connected or in contact with each other through other elements.

The driving unit 300 may independently drive the first to fourth wheels 210, 220, 230, and 240, respectively. The base unit 400 may include a first base plate 410 fixedly installed on the base surface 210a of the first wheel 210 to be connected to the first wheel 210, a second base plate 420 fixedly installed on the base surface 220a of the second wheel 220 to be connected to the second wheel 220, a third base plate 430 fixedly installed on the base surface 230a of the third wheel 230 to be connected to the third wheel 230, and a fourth base plate 440 fixedly installed on the base surface 240a of the fourth wheel 240 to be connected to the fourth wheel 240. In this case, the second wheel 220 and the third wheel 230 may be provided such that the base surfaces 220a and 230a are in contact with each other, which may be the second base plate 420 and the third base plate 430 being in contact with each other. The first to fourth base plates 410, 420, 430, and 440 may be fixedly installed not to rotate, and inclination angles of the first to fourth base plates 410, 420, 430, and 440 may be changed, depending on rotation of the first to fourth wheels 210, 220, 230, and 240.

More specifically, the driving unit 300 may include a first driving gear 310 provided on one surface of the first base plate 410 and a first driving motor 311 connected to the first driving gear 310, a second driving gear 320 provided on one surface of the second base plate 420 and a second driving motor 321 connected to the second driving gear 320, a third driving gear 330 provided on one surface of the third base plate 430 and a third driving motor 331 connected to the third driving gear 330, and a fourth driving gear 340 provided on one surface of the fourth base plate 440 and a fourth driving motor 341 connected to the fourth driving gear 340. The first to fourth driving motors 311, 321, 331, and 341 may be provided to be driven independently, thereby allowing the first to fourth wheels 210, 220, 230, and 240 to rotate independently. For example, the first to fourth driving motors 311, 321, 331, and 341 may have a driving gear (not illustrated) installed therein to rotate while engaging with the first to fourth driving gears 310, 320, 330, and 340, respectively.

In addition, the driving unit 300 may include a first driving shaft 312 provided in the first wheel 210 and connected to the first driving gear 310 to rotate the first wheel 210, a second driving shaft 322 provided in the second wheel 220 and connected to the second driving gear 320 to rotate the second wheel 220, a third driving shaft 332 provided in the third wheel 230 and connected to the third driving gear 330 to rotate the third wheel 230, and a fourth driving shaft 342 provided in the fourth wheel 240 and connected to the fourth driving gear 340 to rotate the fourth wheel 240.

In addition, the driving unit 300 may include first and second connecting members 312a and 322a connecting the first driving shaft 312 and the second driving shaft 322, and third and fourth connecting members 332a and 342a connecting the third driving shaft 332 and the fourth driving shaft 342. The first to fourth connecting members 312a, 322a, 332a, and 342a may be rotatably connected to the first to fourth driving shafts 312, 322, 332, and 342. For example, even when the first and second driving shafts 312 and 322 are connected by the first and second connecting members 312a and 322a, rotational power of the first driving shaft 312 may not be transmitted to the second driving shaft 322, and the first to fourth driving shafts 312, 322, 332, and 342 may be connected for the purpose of connecting the base plates 410, 420, 430, and 440. When necessary, the driving shafts may not be connected, and a separate connecting shaft of the base plates 410, 420, 430, and 440 may be provided. In this case, the first to fourth connecting members 312a, 322a, 332a, and 342a may be universal joints, as illustrated in the drawings, but, unlike this, may be formed of a flexible material, or helical joints or the like may be used, without limitation thereto, so long as connection is maintained even when a position or an angle of a rotation axis is changed, depending on rotation of each of the wheels 210, 220, 230, and 240, and the like.

The support member 500 may be provided at a point in which the first and second driving shafts 312 and 322 meet or a point in which the third and fourth driving shafts 332 and 342 meet, and may include a first support member 510 installed on the first wheel 210, a second support member 520 installed on the second wheel 220, a third support member 530 installed on the third wheel 230, and a fourth support member 540 installed on the fourth wheel 240. The first to fourth support members 510, 520, 530, and 540 may support the first to fourth wheels 210, 220, 230, and 240 to rotate without slipping, and the first and second support members 510 and 520 may have a hemispherical shape cut centered on a surface in which the first wheel 210 and the second wheel 220 are in contact with each other, and the third and fourth support members 530 and 540 may have a hemispherical shape cut centered on a surface in which the third wheel 230 and the fourth wheel 240 are in contact with each other.

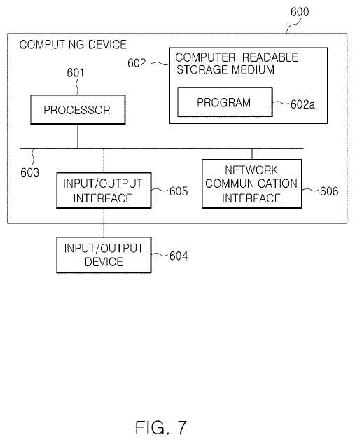

A control device 1 for a rotating cylinder according to an embodiment of the present disclosure may be controlled by a computing device 600 illustrated in FIG. 7. As illustrated in FIG. 7, the computing device 600 may include at least one processor 601, a computer-readable storage medium 602, and a communication bus 603. In this case, the control device 1 for a rotating cylinder according to an embodiment of the present disclosure may include a memory storing instructions for performing operations, and the processor 601 controlling the driving unit 300 to rotate at least one of the first to fourth wheels 210, 220, 230, and 240 by executing the instructions, to adjust an inclination angle to a preset target value.

The processor 601 may cause the computing device 600 to operate according to the embodiment mentioned above. For example, the processor 601 may execute one or more programs stored in the computer-readable storage medium 602. The one or more programs may include one or more computer-executable instructions, which, when executed by the processor 601, may be configured to cause the computing device 600 to perform operations according to the embodiments.

The computer-readable storage medium 602 may be configured to store computer-executable instructions, such as program code, program data, and/or other suitable forms of information. A program 602a stored on the computer-readable storage medium 602 may include a set of instructions executable by the processor 601. In an embodiment, the computer-readable storage medium 602 may be a memory (a volatile memory, such as a random access memory, a nonvolatile memory, or a suitable combination thereof), one or more magnetic disk storage devices, optical disk storage devices, flash memory devices, or any other form of storage medium that may be accessible by the computing device 600 and capable of storing desired information, or a suitable combination thereof.

The communication bus 603 may interconnect various other components of the computing device 600, including the processor 601 and the computer-readable storage medium 602.

The computing device 600 may also include one or more input/output interfaces 605 providing interfaces for one or more input/output devices 604, and one or more network communication interfaces 606. The input/output interfaces 605 and the network communication interfaces 606 may be coupled to the communication bus 603.

The input/output devices 604 may be connected to other components of the computing device 600 via the input/output interfaces 605. Examples of the input/output devices 604 may include input devices such as pointing devices (such as a mouse or trackpad), keyboards, touch input devices (such as a touchpad or touchscreen), voice or sound input devices, various types of sensor devices, and/or photographing devices, and/or output devices such as display devices, printers, speakers, and/or network cards. The examples of the input/output device 604 may be included in the computing device 600 as a component constituting the computing device 600, or may be connected to the computing device 600 as a separate device distinct from the computing device 600.

Thereby, a control device 1 for a rotating cylinder according to an embodiment of the present disclosure may adjust an inclination angle of the rotating cylinder 200 by rotation of the first to fourth wheels 210, 220, 230, and 240, and, in this case, the inclination angle of the rotating cylinder 200 may mean the inclination angle of the fourth base plate 440 located in an uppermost portion. Since a control device 1 for a rotating cylinder according to an embodiment of the present disclosure may perform inclination angle control according to surface contact of the rotating cylinder 200, the inclination angle control of a high-load material may be more precise than inclination angle control according to point contact. Furthermore, a control device 1 for a rotating cylinder according to an embodiment of the present disclosure may rotate an angle of an object placed on the fourth base plate 440 as desired, and thus may be applied to robot arms, artificial joints, or the like.

Furthermore, in a process of controlling the inclination angle by the processor 601, a control device 1 for a rotating cylinder according to an embodiment of the present disclosure may set virtual X-axis and virtual Y-axis as an orthogonal coordinate system on the base surface 220a of the second wheel 220 located in an upper portion of the first rotary unit 201 and the base surface 240a of the fourth wheel 240 located in an upper portion of the second rotary unit 202, may input change values in X-axis and Y-axis inclination angles of at least one of the preset first rotary unit 201 or the preset second rotary unit 202 to calculate rotation angles of the first to fourth wheels 210, 220, 230, and 240 by the following mathematical formulas 1 and 2, and may rotate at least one of the first to fourth wheels 210, 220, 230, and 240 by the calculated rotation angles, to control the inclination angle of the rotating cylinder 200. As described above, the inclination angle of the rotating cylinder 200 may refer to the inclination angle of the fourth wheel 240 located in an uppermost portion.

$$\begin{matrix}{C}_{x 1} = ω1 \cdot cos {θ}_{1} + ω2 \cdot cos {θ}_{2} , \\ {C}_{x 2} = ω3 \cdot cos {θ}_{3} + ω4 \cdot cos {θ}_{4}\end{matrix} \qquad Mathematical Formula 1$$

$$\begin{matrix}{C}_{Y 1} = ω1 \cdot sin {θ}_{1} + ω2 \cdot sin {θ}_{2} , \\ {C}_{Y 2} = ω3 \cdot sin {θ}_{3} + ω4 \cdot sin {θ}_{4}\end{matrix} \qquad Mathematical Formula 2$$

In this case, θ₁, θ₂, θ₃, and θ₄ are rotation angles (counterclockwise) of the first to fourth wheels, respectively, w₁, w₂, w₃, and w₄ are deflection angles of the first to fourth wheels, respectively, C_{X1} is a change value in X-axis inclination angle of the first rotary unit, C_{Y1} is a change value in Y-axis inclination angle of the first rotary unit, C_{X2} is a change value in X-axis inclination angle of the second rotary unit, and C_{Y2} is a change value in Y-axis inclination angle of the second rotary unit. In this case, the mathematical formulas 1 and 2 may be explained by the mathematical formulas a and b described above.

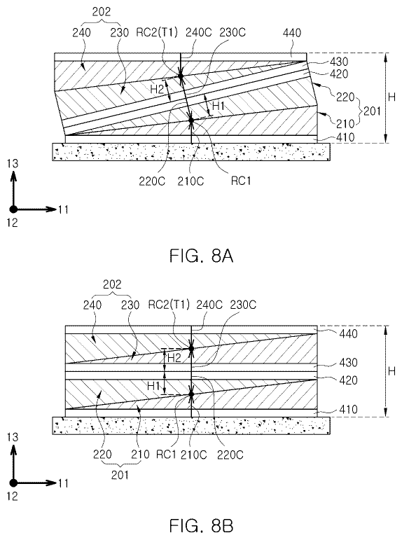

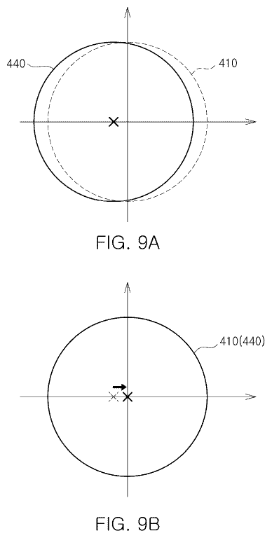

FIGS. 8A, 8B, 9A, and 9B schematically illustrate usage status diagrams of a control device 1 for a rotating cylinder according to an embodiment of the present disclosure. More specifically, FIG. 8A is a conceptual diagram illustrating a first state in which horizontality of the rotating cylinder 200 is aligned, and FIG. 8B is a conceptual diagram illustrating a second state after correcting coordinates of the first reference point in FIG. 8A. In addition, FIG. 9A is a conceptual diagram illustrating FIG. 8A as viewed in the first direction 11, and FIG. 9B is a conceptual diagram illustrating FIG. 8B as viewed in the first direction 11. Hereinafter, a control device 1 for a rotating cylinder according to an embodiment of the present disclosure will be described with reference to FIGS. 8A, 8B, 9A, and 9B, and FIGS. 6 and 7 will be described together.

A control device 1 for a rotating cylinder according to an embodiment of the present disclosure may correct coordinates of a first reference point while maintaining an inclination angle of a rotating cylinder 200 adjusted in a process of controlling an inclination angle by a processor 601. In the specification of the present disclosure, the first reference point may mean a point in which a third rotation axis 230c and a fourth rotation axis 240c intersect.

A control device 1 for a rotating cylinder according to an embodiment of the present disclosure may correct coordinates T1 of the first reference point of the rotating cylinder 200 in which the rotation axes 230c and 240c of third and fourth wheels intersect while maintaining the inclination angle of the rotating cylinder 200 adjusted by the processor 601. In the specification of the present disclosure, rotation axes 210c, 220c, 230c, and 240c of first to fourth wheels may mean a line, from and perpendicular to one surface of the base plate 410, 420, 430, and 440 of each of the wheels to rotation centers RC1 and RC2 of each of the wheels. For example, a third rotation axis 230c, which may be a rotation axis of a third wheel 230, may mean a line from a third base surface 230a to a second rotation center RC2, and a fourth rotation axis 240c, which may be a rotation axis of a fourth wheel 240, may mean a line from a fourth base surface 240a to the second rotation center RC2. In this case, a length of a first rotation axis 210c and a length of a second rotation axis 220c may be the same, and in the mathematical formula described below, a rotation axis length H1 of a first rotary unit 201 may mean either the length of the first rotation axis 210c or the length of the second rotation axis 220c. Similarly, a length of the third rotation axis 230c and a length of the fourth rotation axis 240c may be the same, and in the mathematical formula described below, a rotation axis length H2 of a second rotary unit 202 may mean either a length of the third rotation axis 230c or a length of the fourth rotation axis 240c.

Referring to FIGS. 8A and 9A, the inclination angle of the rotating cylinder 200 may be in a state in which the X-axis and Y-axis inclination angles are 0° and are aligned horizontally, but an X-coordinate of the first reference point T1 may be at a position of −10.4 mm with respect to an origin. In this case, the processor 601 may rotate at least one of the first to fourth wheels 210, 220, 230, and 240 such that the X-coordinate of the first reference point T1 reaches the origin. Therefore, as illustrated in FIGS. 8B and 9B, the inclination angle of the rotating cylinder 200 may be in a state in which the X-axis and Y-axis inclination angles are 0° and are aligned horizontally, and at the same time, an X-coordinate and a Y-coordinate of the first reference point T1 may be located at an origin. For example, in the process of controlling the inclination angle of the rotating cylinder 200, when the coordinate of the first reference point T1 deviates from a preset target coordinate, the processor 601 may correct the coordinate of the first reference point T1 by rotating at least one of the first to fourth wheels 210, 220, 230, and 240 while maintaining an adjusted inclination angle.

Furthermore, although not illustrated in the drawing, the processor 601 may calculate the rotation angle of each of the wheels 210, 220, 230, and 240 for correcting an X-coordinate, a Y-coordinate, or a Z-coordinate of the first reference point T1 while maintaining the adjusted inclination angle. In this case, in a state in which horizontality is aligned, the Z-coordinate of the first reference point T1 may mean a value excluding the length of the rotation axis 240c of the fourth wheel 240 located in an uppermost portion, from a height H, so the height H described in the table below means a value +30 mm from the Z-coordinate of the first reference point T1.

More specifically, in a process of correcting the coordinates of the first reference point T1, when the X-coordinate of the first reference point T1 moves by ΔX as a preset value, the processor 601 may calculate changed X-axis inclination angles of the first rotary unit 201 and the second rotary unit 202 by the following mathematical formula 3, may input a change value in inclination angle, a difference in values between the X-axis inclination angles of the first rotary unit 201 and the second rotary unit 202 and current X-axis inclination angles of the first rotary unit 201 and the second rotary unit 202, into the mathematical formula 1, to calculate rotation angles of the first to fourth wheels 210, 220, 230, and 240, and may rotate at least one of the first to fourth wheels 210, 220, 230, and 240 by the calculated rotation angles to correct the X-coordinate of the reference point T1:

$$\begin{matrix}{φ}_{X 1}^{′} = {sin}^{- 1} ( \frac{H 1 \cdot sin {φ}_{X} \text{?} + Δ X}{H 1} ) , \\ {φ}_{X 2}^{′} = - {sin}^{- 1} ( \frac{H 2 \cdot sin {φ}_{X} \text{?} + Δ X}{H 2} )\end{matrix} \qquad Mathematical Formula 3$$

$$\text{?} \text{indicates text missing or illegible when filed}$$

In this case,

$${φ}_{X 1}^{′} and {φ}_{X 2}^{′}$$

are X-axis inclination angles of the first and second rotary units after correction, φ_{X1} and φ_{X2} are current X-axis inclination angles of the first and second rotary units, H1 is a rotation axis length of the first rotary unit, and H2 is a rotation axis length of the second rotary unit.

For example, when the rotating cylinder 200 is formed of four wheels 210, 220, 230, and 240 of which rotation axis lengths are 30 mm, a first state in which horizontality is aligned may be expressed as Table 1 below.

TABLE 1

| | Rotation | X-axis | Y-axis | | | |
|---|---|---|---|---|---|---|
| | Angle | Inclination | Inclination | X-coordinate | Y-coordinate | Height |
| | (°) | Angle (°) | Angle (°) | (mm) | (mm) | (mm) |
| Total | — | 0 | 0 | −10.4 | 0 | 119.088 |
| 2^{nd} Rotary Unit | | −10 | 0 | | | |
| 4^{th} Wheel | 60 | −5 | 8.66 | 0 | 0 | 30 |
| 3^{rd} Wheel | 300 | −5 | −8.66 | −5.2 | 0 | 29.5442 |
| 1^{st} Rotary Unit | | 10 | 0 | | | |
| 2^{nd} Wheel | 120 | 5 | 8.66 | −5.2 | 0 | 29.5442 |
| 1^{st} Wheel | 240 | 5 | −8.66 | 0 | 0 | 30 |

In this case, when it is desired to move the X-coordinate of the first reference point T1 by 1 mm, the processor 601 may calculate the rotation angles of the first to fourth wheels 210, 220, 230, and 240 by the mathematical formula 3 above, and may be organized and expressed as in Table 2 below.

TABLE 2

| | Rotation | X-axis | Y-axis | | | |
|---|---|---|---|---|---|---|
| | Angle | Inclination | Inclination | X-coordinate | Y-coordinate | Height |
| | (°) | Angle (°) | Angle (°) | (mm) | (mm) | (mm) |
| Total | — | 0 | 0 | −9.4 | 0 | 119.256 |
| 2^{nd} Rotary Unit | | −9.04 | 0 | | | |
| 4^{th} Wheel | 63.15 | −4.52 | 8.92 | 0 | 0 | 30 |
| 3^{rd} Wheel | 296.85 | −4.52 | −8.92 | −4.7 | 0 | 29.628 |
| 1^{st} Rotary Unit | | 9.04 | 0 | | | |
| 2^{nd} Wheel | 116.85 | 4.52 | 8.92 | −4.7 | 0 | 29.628 |
| 1^{st} Wheel | 243.15 | 4.52 | −8.92 | 0 | 0 | 30 |

As illustrated in Table 3 above, a control device 1 for a rotating cylinder according to an embodiment of the present disclosure can confirm that the length of the height H, that is, the Z-coordinate of the first reference point T1, changes when moving the X-coordinate while maintaining the Y-coordinate.

Similarly, in the process of correcting the coordinates of the first reference point T1 by the processor 601, when the Y-coordinate of the first reference point T1 is changed by ΔY as a preset value, the Y-axis inclination angles of the first rotary unit 201 and the second rotary unit 202 may be calculated by mathematical formula 4, and the change in inclination angle, which may be the difference in values between the calculated Y-axis inclination angles of the first rotary unit 201 and the second rotary unit 202 and the current Y-axis inclination angles of the first rotary unit 201 and the second rotary unit 202, may be input into mathematical formula 2 to calculate the rotation angles of the first to fourth wheels 210, 220, 230, and 240, and at least one of the first to fourth wheels 210, 220, 230, and 240 may rotate by the calculated rotation angle to correct the Y-coordinate of the reference point T1:

$$\begin{matrix}{φ}_{Y 1}^{′} = {sin}^{- 1} ( \frac{H 1 \cdot sin {φ}_{Y} \text{?} + Δ Y}{H 1} ) , \\ {φ}_{Y 2}^{′} = - {sin}^{- 1} ( \frac{H 2 \cdot sin {φ}_{Y} \text{?} + Δ Y}{H 2} )\end{matrix} \qquad Mathematical Formula 4$$

$$\text{?} \text{indicates text missing or illegible when filed}$$

In this case,

$$φ {}_{Y 1}^{′} and φ {}_{Y 2}^{′}$$

are Y-axis inclination angles of the first and second rotary units after correction, on φ_{Y1} and φ_{Y2} are current Y-axis inclination angles of the first and second rotary units, H1 is a rotation axis length of the first rotary unit, and H2 is a rotation axis length of the second rotary unit.

For example, in the state of Table 2, when it is desired to move the Y-coordinate of the first reference point T1 by −1 mm, the processor 601 may calculate the rotation angles of the first to fourth wheels 210, 220, 230, and 240 by the mathematical formula 4, and may be organized and expressed as in Table 3 below.

TABLE 3

| | Rotation | X-axis | Y-axis | | | |
|---|---|---|---|---|---|---|
| | Angle | Inclination | Inclination | X-coordinate | Y-coordinate | Height |
| | (°) | Angle (°) | Angle (°) | (mm) | (mm) | (mm) |
| Total | — | 0 | 0 | −9.4 | −1 | 119.248 |
| 2^{nd} Rotary Unit | | −10 | 0.95 | | | |
| 4^{th} Wheel | 69.0285 | −3.58 | 9.34 | 0 | 0 | 30 |
| 3^{rd} Wheel | 303.043 | −5.45 | −8.38 | −4.7 | −0.5 | 29.6239 |
| 1^{st} Rotary Unit | | 9.03 | −0.95 | | | |
| 2^{nd} Wheel | 123.043 | 5.45 | 8.38 | −4.7 | −0.5 | 29.6239 |
| 1^{st} Wheel | 249.028 | 3.58 | −9.34 | 0 | 0 | 30 |

As illustrated in Table 3 above, a control device 1 for a rotating cylinder according to an embodiment of the present disclosure can confirm that the length of the height H, that is, the Z-coordinate of the first reference point T1, changes when moving the Y-coordinate while maintaining the X-coordinate.

Similarly, in the process of correcting the coordinates of the first reference point T1 by the processor 601, when the Z-coordinate of the first reference point T1 is changed by ΔZ as a preset value, the X-axis inclination angles of the first rotary unit 201 and the second rotary unit 202 may be calculated by the following mathematical formula 5, and the change in inclination angle, which may be the difference in values between the calculated X-axis inclination angles of the first rotary unit 201 and the second rotary unit 202 and the current X-axis inclination angles of the first rotary unit 201 and the second rotary unit 202, may be input into the mathematical formula 1 to calculate the rotation angles of the first to fourth wheels 210, 220, 230, and 240, and at least one of the first to fourth wheels 210, 220, 230, and 240 may rotate by the calculated rotation angle to correct the Z-coordinate of the reference point:

$$φ {}_{X 1}^{′} = {cos}^{- 1} ( \frac{H 1 \cdot cos {φ}_{x 1} + Δ Z}{H 1} ) , φ {}_{X 2}^{′} = - {cos}^{- 1} ( \frac{H 2 \cdot cos {φ}_{x 2} + Δ Z}{H 2} ) \qquad Mathematical Formula 5$$

In this case,

$$φ {}_{X 1}^{′} and φ {}_{X 2}^{′}$$

are X-axis inclination angles of the first and second rotary units after correction, φ_{X1} and φ_{X2} are current X-axis inclination angles of the first and second rotary units, H1 is a rotation axis length of the first rotary unit, and H2 is a rotation axis length of the second rotary unit.

For example, in the state of Table 3, when it is desired to move the Z-coordinate of the first reference point T1 by −1 mm, the processor 601 may calculate the rotation angles of the first to fourth wheels 210, 220, 230, and 240 by the mathematical formula 5, and may be organized and expressed as in Table 4 below.

TABLE 4

| | Rotation | X-axis | Y-axis | | | |
|---|---|---|---|---|---|---|
| | Angle | Inclination | Inclination | X-coordinate | Y-coordinate | Height |
| | (°) | Angle (°) | Angle (°) | (mm) | (mm) | (mm) |
| Total | — | 0 | 0 | −14.36 | −1 | 118.248 |
| 2^{nd} Rotary Unit | | −13.85 | −0.95 | | | |
| 4^{th} Wheel | 42.10 | −7.42 | 6.70 | 0 | 0 | 30 |
| 3^{rd} Wheel | 310.00 | −6.43 | −7.65 | −7.18 | −0.5 | 29.124 |
| 1^{st} Rotary Unit | | 13.85 | 0.95 | | | |
| 2^{nd} Wheel | 130.01 | 6.43 | 7.65 | −7.18 | −0.5 | 29.124 |
| 1^{st} Wheel | 222.11 | 7.42 | −6.70 | 0 | 0 | 30 |

As illustrated in Table 3 above, a control device 1 for a rotating cylinder according to an embodiment of the present disclosure can confirm that the X-coordinate of the first reference point T1 changes when moving the Z-coordinate while maintaining the Y-coordinate.

For example, according to a control device 1 for a rotating cylinder according to an embodiment of the present disclosure, the inclination angle of the rotating cylinder 200 may be maintained while simultaneously correcting the X, Y, and Z-coordinates of the first reference point T1 to any desired value. As described above, when moving any one of the X, Y, or Z-coordinates of the first reference point T1, there may be a problem that any one of the remaining two coordinates changes. For example, as described above, when moving the Y-coordinate while maintaining the X-coordinate of the reference point T1, the Z-coordinate may change.

In the above, the change in coordinates depending on the rotations of the wheels of the rotating cylinder may be explained through the mathematical formulas described above, but in addition to the mathematical formulas described above, it is also possible to calculate it through another method, for example, Euler coordinate transformation.

For example, the change in coordinates depending on the rotation of each of the wheels may be calculated from the change through rows and columns of three-dimensional X-axis rotation, Y-axis rotation, and Z-axis rotation, and through this, it is also possible to calculate a rotation value of each wheel to change a target reference point to a target position.

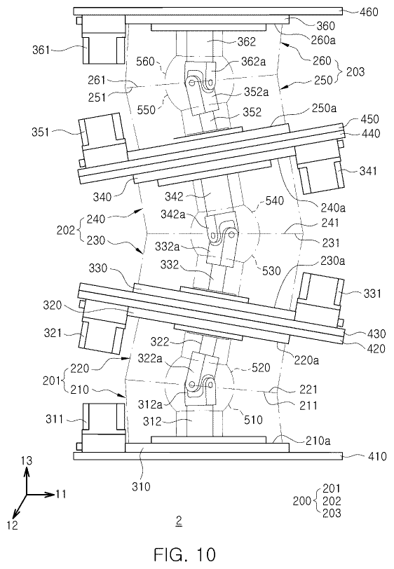

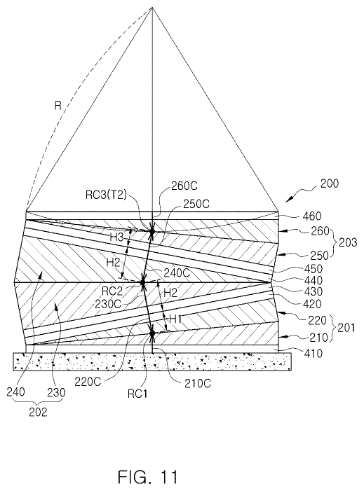

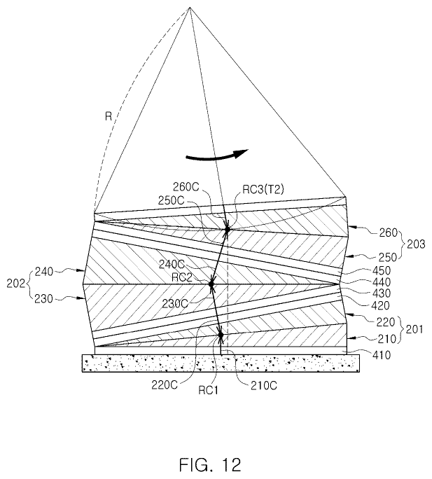

FIGS. 10 to 12 illustrate a control device 2 for a rotating cylinder according to another embodiment of the present disclosure. More specifically, FIG. 10 is a schematic plan view of a control device 2 for a rotating cylinder according to another embodiment of the present disclosure, and FIGS. 11 and 12 are usage status diagrams of a control device 2 for a rotating cylinder according to another embodiment of the present disclosure. Hereinafter, a control device 2 for a rotating cylinder according to another embodiment of the present disclosure will be described with reference to FIGS. 10 to 12. The same reference numerals may be used for common components with respect to the control device 1 for a rotating cylinder according to an embodiment of the present disclosure, and differences will be mainly described.

A control device 2 for a rotating cylinder according to another embodiment of the present disclosure may further include a rotating cylinder 200 including a first rotary unit 201, a second rotary unit 202, and a third rotary unit 203 connected to the second rotary unit 202, and may include a driving unit 300, a base unit 400, and a support unit 500. The third rotary unit 203 may include a fifth wheel 250 and a sixth wheel 260 disposed such that inclined surfaces 251 and 261 forming deflection angles w5 and w6 based on base surfaces 250a and 260a, respectively, are in contact with each other. In this case, the fifth wheel 250 and the sixth wheel 260 may be disposed sequentially from a ground, similar to the first to fourth wheels 210, 220, 230, and 240, and the base surface 250a of the fifth wheel 250 may be disposed to be in contact with a base surface 240a of a fourth wheel 240. In addition, the fifth wheel 250 and the sixth wheel 260 may be rotatably disposed with the same third rotation center RC3, and the driving unit 300 may independently drive the first to sixth wheels 210, 220, 230, 240, 250, and 260.

The base unit 400 may include a fifth base plate 450 fixedly installed on the base surface 250a of the fifth wheel 250 to be connected to the fifth wheel 250, and a sixth base plate 460 fixedly installed on the base surface 260a of the sixth wheel 260 to be connected to the sixth wheel 260. In this case, the fifth and sixth wheels 250 and 260 may be provided such that the base surfaces 250a and 260a are in contact with each other, and more specifically, the fifth base plate 450 and the sixth base plate 460 may be provided to be in contact with each other. In this case, the first to sixth base plates 410, 420, 430, 440, 450, and 460 may be installed fixedly not to rotate, and inclination angles of the first to sixth base plates 410, 420, 430, 440, 450, and 460 may be changed, depending on rotation of the first to sixth wheels 210, 220, 230, 240, 250, and 260.

The driving unit 300 may further include a fifth driving gear 350 provided on one surface of the fifth base plate 450, a fifth driving motor 351 connected to the fifth driving gear 350, a sixth driving gear 360 connected to the sixth base plate 460, and a sixth driving motor 361 connected to the sixth driving gear 360. The fifth and sixth driving motors 351 and 361 may be provided to be driven independently, and thereby the fifth and sixth wheels 250 and 260 may also be rotated independently. For example, the fifth and sixth driving motors 351 and 361 may have driving gears (not illustrated) installed therein to rotate by engaging with the fifth and sixth driving gears 350 and 360, respectively.

In addition, the driving unit 300 may further include a fifth driving shaft 352 provided inside the fifth wheel 250 and connected to the fifth driving gear 350 to rotate the fifth wheel 250, and a sixth driving shaft 362 provided inside the sixth wheel 260 and connected to the sixth driving gear 360 to rotate the sixth wheel 260. In addition, the driving unit 300 may further include fifth and sixth connecting members 352a and 362a connecting the fifth driving shaft 352 and the sixth driving shaft 362, and the fifth and sixth connecting members 352a and 362a may be universal joints, as illustrated in the drawings, but, unlike this, may be formed of a flexible material, or helical joints or the like. The fifth to sixth connecting members 352a and 362a may be rotatably connected to the fifth to sixth driving shafts 352 and 362. For example, even when the fifth and sixth driving shafts 352 and 362 are connected by the fifth and sixth connecting members 352a and 362a, rotational power of the fifth driving shaft 352 may not be transmitted to the sixth driving shaft 362, and the fifth to sixth driving shafts 352 and 362 may be connected for the purpose of connecting the base plates 450 and 460. When necessary, the driving shafts may not be connected, and a separate connecting shaft of the base plates 450 and 460 may be provided.

The support member 500 may be provided at a point in which the fifth driving shaft 352 and the sixth driving shaft 362 meet, and may further include a fifth support member 550 installed on the fifth wheel 250, and a sixth support member 560 installed on the sixth wheel 260. The fifth support member 550 and the sixth support member 560 may support the fifth wheel 250 and the sixth wheel 260 to rotate without slipping, and the fifth and sixth support members 550 and 560 may have a hemispherical shape cut centered on a surface in which the fifth wheel 250 and the sixth wheel 260 are in contact with each other.

Furthermore, a control 2 of a rotating cylinder according to another embodiment of the present disclosure may be controlled by a computing device 600 (see FIG. 8), as illustrated in FIG. 8. The computing device 600 (see FIG. 8) may include at least one processor 601 (see FIG. 8), a computer-readable storage medium 602 (see FIG. 8), and a communication bus 603 (see FIG. 8). In this case, the control device 2 of a rotating cylinder according to another embodiment of the present disclosure may include a memory storing instructions, and the processor 601 controlling the driving unit 300 to rotate at least one of the first to sixth wheels 210, 220, 230, 240, 250, and 260 by executing the instructions, to adjust an inclination angle to a preset target value.

In this case, in a process of controlling the inclination angle of the rotating cylinder 200, the processor 601 may set virtual X-axis and virtual Y-axis as an orthogonal coordinate system on the base surface 220a of the second wheel 220 located in an upper portion of the first rotary unit 201, the base surface 240a of the fourth wheel 240 located in an upper portion of the second rotary unit 202, and the base surface 260a of the sixth wheel 260 located in an upper portion of the third rotary unit 203, may input a change values in X-axis and Y-axis inclination angles of at least one of the preset first to third rotary units 201, 202, and 203 to calculate rotation angles of the first to sixth wheels 210, 220, 230, 240, 250, and 260 by the following mathematical formulas 6 and 7, and may rotate at least one of the first to sixth wheels 210, 220, 230, 240, 250, and 260 by the calculated rotation angles, to control the inclination angle:

$${C}_{\times 1} = ω1 \cdot cos {⊖}_{1} + ω2 \cdot cos {⊖}_{2} , \qquad Mathematical Formula 6$$

$${C}_{\times 2} = ω3 \cdot cos {⊖}_{3} + ω4 \cdot cos {⊖}_{4} ,$$

$${C}_{\times 3} = ω5 \cdot cos {⊖}_{5} + ω6 \cdot cos {⊖}_{6}$$

$${C}_{Y 1} = ω1 \cdot sin {θ}_{1} + ω2 \cdot sin {θ}_{2} , \qquad Mathematical Formula 7$$

$${C}_{Y 2} = ω3 \cdot sin {θ}_{3} + ω4 \cdot sin {θ}_{4} ,$$

$${C}_{Y 3} = ω5 \cdot sin {θ}_{5} + ω6 \cdot sin {θ}_{6}$$

Where, θ₁, θ₂, θ₃, θ₄, θ₅, and θ₆ are rotation angles (counterclockwise) of the first to sixth wheels, respectively, w₁, w₂, w₃, w₄, w₅, and w₆ are deflection angles of the first to sixth wheels, respectively, C_{X1} is a change value in X-axis inclination angle of the first rotary unit, C_{Y1} is a change value in Y-axis inclination angle of the first rotary unit, C_{X2}a is a change value in X-axis inclination angle of the second rotary unit, C_{Y2} is a change value in Y-axis inclination angle of the second rotary unit, C_{X3} is a change value in X-axis inclination angle of the third rotary unit, and C_{Y3} is a change value in Y-axis inclination angle of the third rotary unit. The mathematical formulas 6 and 7 may be explained by the mathematical formulas a and b described above.

Furthermore, the control device 2 of a rotating cylinder according to another embodiment of the present disclosure may correct a coordinate T2 of the second reference point of the rotating cylinder 200 in which the rotation axes 230c and 240c of the fifth and sixth wheels intersect while maintaining the inclination angle of the rotating cylinder 200 adjusted by the processor 601. In this case, the second reference point T2 may be the same as a third rotation center RC3.

In the specification of the present disclosure, rotation axes 250c and 260c of the fifth and sixth wheels may mean a line, from and perpendicular to the base surface 250a and 260a of each wheel to the third rotation center RC3. For example, a fifth rotation axis 250c, which may be a rotation axis of the fifth wheel 250, may mean a line from the fifth base surface 250a to the third rotation center RC3, and a sixth rotation axis 260c, which may be a rotation axis of the sixth wheel 260, may mean a line from the sixth base surface 260a to the third rotation center RC3. In this case, a length of the fifth rotation axis 250c and a length of the sixth rotation axis 260c may be the same, and in the mathematical formula described below, a rotation axis length H3 of the third rotary unit 203 may mean either the length of the fifth rotation axis 250c or the sixth rotation axis 260c.

For example, the control device 2 of a rotating cylinder according to another embodiment of the present disclosure, similar to the control device 1 for a rotating cylinder according to an embodiment of the present disclosure, in the process of controlling the inclination angle of the rotating cylinder 200, when the coordinate of the second reference point T2 deviates from a preset target coordinate, the processor 601 may maintain the adjusted inclination angle, and, at the same time, may rotate at least one of the first to sixth wheels 210, 220, 230, 240, 250, and 260 to correct one of the X-coordinate, the Y-coordinate, or the Z-coordinate of the second reference point T2. In this case, the Z-coordinate of the second reference point T2 may mean a value excluding the length H3 of the rotation axis 260c of the sixth wheel 260 located in an uppermost portion, from a height H of the entire rotating cylinder 200, as illustrated in FIG. 11.

The correction of the coordinates of the second reference point T2 may be performed by first correcting the X or Y-coordinate excluding the Z-coordinate, then correcting the Z-coordinate, and then correcting a remaining one. Since calculation of correction of the X or Y-coordinate may be relatively easy compared to the Z-coordinate, it can be advantageous to first correct the X and Y-coordinates and then correct the Z-coordinate. In addition, even when correction of all coordinates is completed, the X or Z-coordinate may change again due to correction of the Y-coordinate, so the method of correcting the X and Z-coordinates and then correcting the Y-coordinate may be performed again, and this correction cycle may be performed repeatedly until it falls within a certain range of error.

FIG. 11 illustrates a third state as an example in which the rotating cylinder 200 is aligned horizontally. In this case, a rotation axis length H1 of the first rotary unit 201 may be 30 mm, a rotation axis length H2 of the second rotary unit 202 may be 50 mm, and a rotation axis length H3 of the third rotary unit 203 may be 30 mm. In the third state, rotation angles of each of the wheels 210, 220, 230, 240, 250, and 260 and a height of the entire rotation cylinder 200 may be expressed as in Table 5 below.

TABLE 5

| | Rotation | X-axis | Y-axis | | | |
|---|---|---|---|---|---|---|
| | Angle | Inclination | Inclination | X-coordinate | Y-coordinate | Height |
| | (°) | Angle (°) | Angle (°) | (mm) | (mm) | (mm) |
| Total | — | 0 | 0 | 0 | 0 | 217.569 |
| 3^{rd} Rotary Unit | | 10 | 0 | | | |
| 6^{th} Wheel | 120 | 5 | 8.66 | 0 | 0 | 30 |
| 5^{th} Wheel | 240 | 5 | −8.66 | 5.21 | 0 | 29.5442 |
| 2^{nd} Rotary Unit | | −20 | 0 | | | |
| 4^{th} Wheel | 60 | −10 | 17.32 | 8.68 | 0 | 49.2404 |
| 3^{rd} Wheel | 300 | −10 | −17.32 | −8.68 | 0 | 49.2404 |
| 1^{st} Rotary Unit | | 10 | 0 | | | |
| 2^{nd} Wheel | 120 | 5 | 8.66 | −5.21 | 0 | 29.5442 |
| 1^{st} Wheel | 240 | 5 | −8.66 | 0 | 0 | 30 |

Although not illustrated in the drawings, the processor 601 may rotate at least one of the first to sixth wheels 210, 220, 230, 240, 250, and 260 to correct the X-coordinate of the second reference point T2 by +3 mm, and may be organized and expressed as in Table 6 below.

TABLE 6

| | Rotation | X-axis | Y-axis | | | |
|---|---|---|---|---|---|---|
| | Angle | Inclination | Inclination | X-coordinate | Y-coordinate | Height |
| | (°) | Angle (°) | Angle (°) | (mm) | (mm) | (mm) |
| Total | — | 0 | 0 | 3 | 0 | 217.54 |
| 3^{rd} Rotary Unit | | 11.092 | 0 | | | |
| 6^{th} Wheel | 123.686 | 5.546 | 8.321 | 0 | 0 | 30 |
| 5^{th} Wheel | 236.314 | 5.546 | −8.321 | 5.772 | 0 | 29.4395 |
| 2^{nd} Rotary Unit | | −20.004 | 0 | | | |
| 4^{th} Wheel | 69.994 | −10.002 | 17.319 | 9.620 | 0 | 49.0658 |
| 3^{rd} Wheel | 300.006 | −10.002 | −17.319 | −7.745 | 0 | 49.3965 |
| 1^{st} Rotary Unit | | 8.911 | 0 | | | |
| 2^{nd} Wheel | 116.458 | 4.455 | 8.953 | −4.647 | 0 | 29.6379 |
| 1^{st} Wheel | 243.542 | 4.455 | −8.953 | 0 | 0 | 30 |

As described in the Table 6, according to the control device 2 of a rotating cylinder according to another embodiment of the present disclosure, when one of the X-coordinate, the Y-coordinate, or the Z-coordinate of the second reference point T2 moves, remaining coordinates may be changed. Therefore, the control device 2 of a rotating cylinder according to another embodiment of the present disclosure may rotate at least one of the first to sixth wheels 210, 220, 230, 240, 250, and 260 to re-correct the changed coordinate to the initial position when the value of one of the remaining coordinates may be changed, in a process of correcting one of the X-coordinate, the Y-coordinate, or the Z-coordinate of the second reference point T2. Therefore, the control device 2 of a rotating cylinder according to another embodiment of the present disclosure may move only one of the X-coordinate, the Y-coordinate, or the Z-coordinate of the second reference point T2 and keep the remaining fixed.

More specifically, in a process of correcting the coordinates of the second reference point T2, when the X-coordinate of the second reference point T2 moves by ΔX as a preset value, the processor 601 may calculate the X-axis inclination angles of the first to third rotary units 201, 202, and 203 by the following mathematical formulas 8 to 11, may repeatedly perform the calculation until the calculated X-axis inclination angles of the first to third rotary units 201, 202, and 203 satisfies the following mathematical formula 11, may input a change value in inclination angle, a difference in values between finally calculated X-axis inclination angles of the first to third rotary units 201, 202, and 203 and current X-axis inclination angles of the first to third rotary units 201, 202, and 203, into the following mathematical formula 6 to calculate rotation angles of the first to sixth wheels 210, 220, 230, 240, 250, and 260, and may rotate at least one of the first to sixth wheels 210, 220, 230, 240, 250, and 260 by the calculated rotation angles to correct the X-coordinate of the second reference point T2:

$$φ {}_{X 1}^{′} = {cos}^{- 1} ( cos {φ}_{x 1} + cos {φ}_{x 3} - cos φ {}_{X 3}^{′} ) \qquad Mathematical Formula 8$$

$$φ {}_{X 3}^{′} = {sin}^{- 1} ( \frac{( H 2 + H 3 ) \cdot sin {φ}_{X 3} + \frac{1}{2} Δ X}{( H 2 + H 3 )} ) \qquad Mathematical Formula 9$$

$${φ}_{x 1} + {φ}_{x 2} + {φ}_{x 3} = 0 , φ {}_{X 1}^{′} + φ {}_{X 2}^{′} + φ {}_{X 3}^{′} = 0 \qquad Mathematical Formula 10$$

$$Mathematical Formula 11$$

$$\vert ( H 1 + \text{} H 2 ) \cdot sin φ {}_{X 1}^{′} + ( H 2 + H 3 ) \cdot sin φ {}_{X 3}^{′} - Δ X \vert < T$$

In this case,

$$φ {}_{X 1}^{′} , φ {}_{X 2}^{′} , and φ {}_{X 3}^{′}$$

are X-axis inclination angles of the first to third rotary units after correction, φ_{X1}, φ_{X2}, and φ_{X3} are current X-axis inclination angles of the first to third rotary units, H1, H2, and H3 are rotation axis lengths of the first to third rotary units, and T is a preset threshold value.

In this case, the height H of the rotating cylinder 200 may be twice a sum of the rotation axis lengths H1, H2, and H3 of the first to third rotary units 203. As illustrated in FIGS. 11 and 12, when the rotation axis lengths H1, H2, and H3 of the first to third rotary units 203 are tilted and the entire rotating cylinder 200 is aligned horizontally, the height H of the rotating cylinder 200 may be expressed as a sum of products of the rotation axis length H3 of the third rotary unit 203 located in an uppermost portion, the rotation axis length H1 of the first rotary unit 201 located in a lowermost portion, and remaining rotation axis lengths (H1+H2, H2+H3) located in a central portion and the inclination angles of each of the rotary units 201, 202, and 203.

For example, the control device 2 of a rotating cylinder according to another embodiment of the present disclosure may perform a numerical analysis method of performing correction up to a threshold value (T) range preset by the mathematical formula 11 for re-correction of the other Z value that changes while correcting the X-coordinate. Therefore, the control device 2 of a rotating cylinder according to another embodiment of the present disclosure may perform correction such that the Z-coordinate value or the height of the rotating cylinder 200 is equal to the initial alignment state described in the Table 5, and may calculate rotation angles of the first to sixth wheels 210, 220, 230, 240, 250, and 260, as illustrated in the following Table 7, by the mathematical formulas 8 to 11.

TABLE 7

| | Rotation | X-axis | Y-axis | | | |
|---|---|---|---|---|---|---|
| | Angle | Inclination | Inclination | X-coordinate | Y-coordinate | Height |
| | (°) | Angle (°) | Angle (°) | (mm) | (mm) | (mm) |
| Total | — | 0 | 0 | 3 | 0 | 217.569 |
| 3^{rd} Rotary Unit | | 11.032 | 0 | | | |
| 6^{th} Wheel | 123.476 | 5.516 | 8.341 | 0 | 0 | 30 |
| 5^{th} Wheel | 236.524 | 5.516 | −8.341 | 5.741 | 0 | 29.4456 |
| 2^{nd} Rotary Unit | | −19.882 | 0 | | | |
| 4^{th} Wheel | 60.195 | −9.941 | 17.354 | 9.568 | 0 | 49.0761 |
| 3^{rd} Wheel | 299.805 | −9.941 | −17.354 | −7.693 | 0 | 49.4047 |
| 1^{st} Rotary Unit | | 8.850 | 0 | | | |
| 2^{nd} Wheel | 116.264 | 4.425 | 8.968 | −4.616 | 0 | 29.6428 |
| 1^{st} Wheel | 243.736 | 4.425 | −8.968 | 0 | 0 | 30 |

Similarly, in a process of correcting the coordinates of the second reference point T2, when the Z-coordinate of the second reference point moves by ΔZ as a preset value, the processor 601 may calculate the X-axis inclination angles of the first to third rotary units 201, 202, and 203 by mathematical formulas 12 to 15, and repeatedly perform the calculation until the calculated X-axis inclination angles of the first to third rotary units 201, 202, and 203 satisfies the mathematical formula 15, may input finally calculated X-axis inclination angles of the first to third rotary units 201, 202, and 203 into the mathematical formula 6 to calculate rotation angles of the first to sixth wheels 210, 220, 230, 240, 250, and 260, and may rotate at least one of the first to sixth wheels 210, 220, 230, 240, 250, and 260 by the calculated rotation angles to correct the Z-coordinate of the second reference point T2:

$$φ {}_{x 1}^{′} = {sin}^{- 1} ( sin {φ}_{x 1} + sin {φ}_{x 3} - sin φ {}_{x 3}^{′} ) \qquad Mathematical Formula 12$$

$$φ {}_{x 3}^{′} = {cos}^{- 1} ( \frac{( H 2 + H 3 ) \cdot cos {φ}_{x 3} + \frac{1}{2} Δ Z}{H 2 + H 3} ) \qquad Mathematical Formula 13$$

$${φ}_{x 1} + {φ}_{x 2} + {φ}_{x 3} = 0 , φ {}_{X 1}^{′} + φ {}_{X 2}^{′} + φ {}_{X 3}^{′} = 0 \qquad Mathematical Formula 14$$

$$Mathematical Formula 15$$

$$\vert ( H 1 + \text{} \text{} H 2 ) \cdot cos φ {}_{X 1}^{′} + ( H 2 + H 3 ) \cdot cos φ {}_{X 3}^{′} - Δ Z \vert < T$$

In this case,

$$φ {}_{X 1}^{′} , φ {}_{X 2}^{′} , and φ {}_{X 3}^{′}$$

are X-axis inclination angles of the first to third rotary units after correction, φ_{X1}, φ_{X2}, and φ_{X3} are current X-axis inclination angles of the first to third rotary units, H1, H2, and H3 are rotation axis lengths of the first to third rotary units, and T is a preset threshold value.

In addition, in the process of correcting the coordinates of the second reference point T2, when the Y-coordinate of the second reference point T2 moves by ΔY as a preset value, the processor 601 may calculate a generated height change ΔZ by mathematical formulas 16 and 17, may calculate the X-axis inclination angles of the first to third rotary units 201, 202, and 203 by mathematical formulas 12 to 15, and repeatedly perform the calculation until the calculated X-axis inclination angles of the first to third rotary units 201, 202, and 203 satisfies mathematical formula 15, may input finally calculated X-axis inclination angles of the first to third rotary units 201, 202, and 203 into mathematical formula 6 to calculate the rotation angles of the first to sixth wheels 210, 220, 230, 240, 250, and 260, and may rotate at least one of the first to sixth wheels 210, 220, 230, 240, 250, and 260 by the calculated rotation angle to correct the Y-coordinate of the second reference point:

$$φ {}_{Y 1}^{′} = {sin}^{- 1} ( \frac{H \cdot sin {φ}_{Y 1} + \frac{1}{2} Δ Y}{H} ) = φ {}_{Y 3}^{′} = {sin}^{- 1} ( \frac{H \cdot sin {φ}_{Y 3} + \frac{1}{2} Δ Y}{H} ) \qquad Mathematical Formula 16$$

$$Mathematical Formula 17$$

$$Δ Z = ( H 1 + H 2 ) \cdot ( cos {φ}_{X 1} \cdot cos {φ}_{Y 1} ) + ( H 2 + H 3 ) \cdot ( cos {φ}_{X 3} \cdot cos {φ}_{Y 3} ) - ( H 1 + H 2 ) \cdot ( cos {φ}_{X 1} \cdot cos φ {}_{Y 1}^{′} ) + ( H 2 + H 3 ) \cdot ( cos {φ}_{X 3} \cdot cos φ {}_{Y 3}^{′} )$$

In this case,

$$φ {}_{Y 1}^{′} and φ {}_{Y 3}^{′}$$

are Y-axis inclination angles of the first and third rotary units after correction, φ_{X1}, φ_{X2}, and φ_{X3} are current X-axis inclination angles of the first to third rotary units, φ_{Y1} and φ_{Y3} are current Y-axis inclination angles of the first and third rotary units, H1, H2, and H3 are rotation axis lengths of the first to third rotary units, and T is a preset threshold value.

For example, since the control device 2 of a rotating cylinder according to another embodiment of the present disclosure may further include the third rotary unit 203 to have one more degree of freedom than the control device 1 for a rotating cylinder according to an embodiment of the present disclosure, such that the coordinates of the second reference point T2 are corrected while maintaining the adjusted inclination angle, and since only one of the X-coordinate, the Y-coordinate, or the Z-coordinate of the second reference point T2 may move and the remaining may be kept fixed, precise correction of the coordinates of the second reference point T2 is possible.

Similar to the previous embodiment, the calculation formula for calculating the change in the coordinates of the second reference point T2 according to the rotation of each of the wheels may also be calculated using a calculation formula based on Euler coordinate transformation, instead of the calculation formula described above.

FIG. 12 shows an example of implementing an operation of a goniometer using a control device 2 of a rotating cylinder according to another embodiment of the present disclosure, and illustrates a fourth state in which a second reference point T2 rotates by 5°.

A goniometer may be a device for precisely adjusting an angle of an object rotating around a fixed axis, and may rotate with a rotation radius (R) based on a fixed center. In this case, as illustrated in FIG. 11, when a reference point of the goniometer is set to a second reference point T2, in order for the rotating cylinder 200 to implement the fourth state in which the goniometer rotates 5°, the coordinates of the second reference point T2 should be corrected to a position that may rotate 5°, as illustrated in FIG. 12. For example, when the rotation radius (R) is 100 mm, the X-coordinate of the second reference point T2 should be corrected to about +8.72 mm and the Z-axis coordinate should be corrected to about +0.38 mm based on the coordinates illustrated in FIG. 11. To this end, the control device 2 of a rotating cylinder according to another embodiment of the present disclosure may correct the X-coordinate and the Z-coordinate of the second reference point T2 to any desired value by rotating at least one of the first to sixth wheels 210, 220, 230, 240, 250, and 260.

Although the first reference point T1 and the second reference point T2 are arbitrarily set and described in the specification of the present disclosure, it is obvious that the same may be applied to any coordinate located inside the rotating cylinder 200. Therefore, according to the control device 2 of a rotating cylinder according to another embodiment of the present disclosure, any coordinate that may occur during horizontality alignment or target inclination angle control may be controlled without affecting the inclination angle or other coordinates of the rotating cylinder. For example, the control device 2 of a rotating cylinder according to another embodiment of the present disclosure may precisely control an inclination angle, a height, and any coordinate of the rotating cylinder.

The present disclosure may align horizontality or precisely control a target angle, and at the same time, may correct a height of a rotating cylinder, by a control device for the rotating cylinder, as mentioned above.

In an embodiment, the present disclosure may precisely correct coordinates and a height of a rotation axis of each wheel that moves according to rotation of six wheels.

While example embodiments have been illustrated and described above, it will be apparent to those skilled in the art that modifications and variations could be made without departing from the scope of the present disclosure as defined by the appended claims.

What is claimed is:

1. A control device for a rotating cylinder comprising:
a first rotary unit including a first wheel and a second wheel, of which inclined surfaces having a deflection angle based on each of base surfaces are disposed to contact each other; a second rotary unit connected to the first rotary unit and including a third wheel and a fourth wheel, of which inclined surfaces having a deflection angle based on each of base surfaces are disposed to contact each other; and a third rotary unit including a fifth wheel and a sixth wheel, of which inclined surfaces having a deflection angle based on each of base surfaces are disposed to contact each other, wherein the first to sixth wheels are disposed in sequence in one direction;
a driving unit independently driving the first to sixth wheels;
a memory storing a command performing an operation; and
a processor connected to the memory and the driving unit to execute the command,
wherein the operation rotates at least one wheel among the first to sixth wheels to control the driving unit such that an inclination angle of the rotating cylinder, an inclination angle of the base surface of the sixth wheel with respect to the base surface of the first wheel, or a position of the base surface of the sixth wheel with respect to the base surface of the first wheel is adjusted to a preset target value.

2. The control device of claim 1, wherein, in the rotating cylinder,
the first to sixth wheels are disposed in sequence in one direction,
wherein the second and third wheels are disposed such that the base surfaces thereof are adjacent and parallel to each other, and the fourth and fifth wheels are disposed such that the base surfaces thereof are adjacent and parallel to each other, and
wherein the first and second wheels have the same first rotation center and are disposed to be rotatable relative to each other, the third and fourth wheels have the same second rotation center and are disposed to be rotatable relative to each other, and the fifth and sixth wheels have the same third rotation center and are disposed to be rotatable relative to each other.

3. The control device of claim 2, wherein the operation controls the driving unit to correct the inclination angle of the rotating cylinder, and, while maintaining the adjusted inclination angle of the rotating cylinder, rotates a plurality of wheels among the first to sixth wheels to correct a coordinate among an X-coordinate, a Y-coordinate, or a Z-coordinate of a second reference point of the rotating cylinder in which rotation axes of the fifth and sixth wheels intersect.

4. The control device of claim 3, wherein, in a process of correcting a coordinate among the X-coordinate, the Y-coordinate, or the Z-coordinate of the second reference point, the operation includes rotating at least one of the first to sixth wheels, to re-correct a changed coordinate in changing one of remaining coordinates to an initial position.

5. The control device of claim 3, wherein, after performing a mathematical calculation of correcting a coordinate among the X-coordinate, the Y-coordinate, or the Z-coordinate of the second reference point, the operation includes performing a mathematical calculation of correcting a first remaining coordinate thereamong, and then performing a mathematical calculation of correcting a second remaining coordinate thereamong.

6. The control device of claim 5, wherein the operation includes repeatedly performing correction of the X-coordinate, the Y-coordinate, or the Z-coordinate of the second reference point until the first and second remaining coordinates fall within a certain range from a target coordinate by correcting a coordinate thereamong.

7. The control device of claim 4, wherein, in a process of controlling the inclination angle of the rotating cylinder, the operation includes:
setting virtual X-axis and virtual Y-axis as an orthogonal coordinate system on the base surface of the second wheel located in an upper portion of the first rotary unit, the base surface of the fourth wheel located in an upper portion of the second rotary unit, and the base surface of the sixth wheel located in an upper portion of the third rotary unit,
inputting change values in X-axis and Y-axis inclination angles of at least one of the preset first to third rotary units to calculate rotation angles of the first to sixth wheels by the following mathematical formulas 1 and 2, and
rotating at least one of the first to sixth wheels by the calculated rotation angles, to control the inclination angle:
$${C}_{\times 1} = ω1 \cdot cos {⊖}_{1} + ω2 \cdot cos {⊖}_{2} , \qquad Mathematical Formula 1$$
$${C}_{\times 2} = ω3 \cdot cos {⊖}_{3} + ω4 \cdot cos {⊖}_{4} ,$$
$${C}_{\times 3} = ω5 \cdot cos {⊖}_{5} + ω6 \cdot cos {⊖}_{6}$$
$${C}_{Y 1} = ω1 \cdot sin {θ}_{1} + ω2 \cdot sin {θ}_{2} , \qquad Mathematical Formula 2$$
$${C}_{Y 2} = ω3 \cdot sin {θ}_{3} + ω4 \cdot sin {θ}_{4} ,$$
$${C}_{Y 3} = ω5 \cdot sin {θ}_{5} + ω6 \cdot sin {θ}_{6}$$
where, θ₁, θ₂, θ₃, θ₄, θ₅, and θ₆ are rotation angles of the first to sixth wheels in a counterclockwise direction, respectively, w₁, w₂, w₃, w₄, w₅, and w₆ are deflection angles of the first to sixth wheels, respectively, C_{X1} is a change value in X-axis inclination angle of the first rotary unit, C_{Y1} is a change value in Y-axis inclination angle of the first rotary unit, C_{X2} is a change value in X-axis inclination angle of the second rotary unit, C_{Y2} is a change value in Y-axis inclination angle of the second rotary unit, C_{X3} is a change value in X-axis inclination angle of the third rotary unit, and C_{Y3} is a change value in Y-axis inclination angle of the third rotary unit.

8. The control device of claim 7, wherein, in a process of correcting the coordinates of the second reference point,
when the X-coordinate of the second reference point moves by ΔX as a preset value,
the operation includes:
calculating the X-axis inclination angles of the first to third rotary units by the following mathematical formulas 3 to 6, and repeatedly performing the calculation until the calculated X-axis inclination angles of the first to third rotary units satisfies the following mathematical formula 6,
inputting a change value in inclination angle, a difference in values between finally calculated X-axis inclination angles of the first to third rotary units and current X-axis inclination angles of the first to third rotary units, into the following mathematical formula 1, to calculate rotation angles of the first to sixth wheels, and
rotating at least one of the first to sixth wheels by the calculated rotation angles to correct the X-coordinate of the second reference point:
$$φ {}_{X 1}^{′} = {cos}^{- 1} ( cos {φ}_{x 1} + cos {φ}_{x 3} - cos φ {}_{X 3}^{′} ) \qquad Mathematical Formula 3$$
$$φ {}_{X 3}^{′} = {sin}^{- 1} ( \frac{( H 2 + H 3 ) \cdot sin {φ}_{x 3} + \frac{1}{2} Δ X}{( H 2 + H 3 )} ) \qquad Mathematical Formula 4$$
$${φ}_{x 1} + {φ}_{x 2} + {φ}_{x 3} = 0 , φ {}_{X 1}^{′} + φ {}_{X 2}^{′} + φ {}_{X 3}^{′} = 0 \qquad Mathematical Formula 5$$
$$Mathematical Formula 6$$
$$\vert ( H 1 + H 2 ) \cdot sin φ {}_{X 1}^{′} + ( H 2 + H 3 ) \cdot sin φ {}_{X 3}^{′} - Δ X \vert < T where , φ {}_{X 1}^{′} , φ {}_{X 2}^{′} , and φ {}_{X 3}^{′}$$
are X-axis inclination angles of the first to third rotary units after correction, φ_{X1}, φ_{X2}, and φ_{X3} are current X-axis inclination angles of the first to third rotary units, H1, H2, and H3 are rotation axis lengths of the first to third rotary units, and T is a preset threshold value.

9. The control device of claim 7, wherein, in a process of correcting the coordinates of the second reference point,
when the Z-coordinate of the second reference point moves by ΔZ as a preset value,
the operation includes:
calculating the X-axis inclination angles of the first to third rotary units by the following mathematical formulas 7 to 10, and repeatedly performing the calculation until the calculated X-axis inclination angles of the first to third rotary units satisfies the following mathematical formula 10,
inputting finally calculated X-axis inclination angles of the first to third rotary units into the following mathematical formula 1 to calculate rotation angles of the first to sixth wheels, and
rotating at least one of the first to sixth wheels by the calculated rotation angles to correct the Z-coordinate of the second reference point:
$$φ {}_{x 1}^{′} = {sin}^{- 1} ( sin {φ}_{x 1} + sin {φ}_{x 3} - sin φ {}_{x 3}^{′} ) \qquad Mathematical Formula 7$$
$$φ {}_{x 3}^{′} = {cos}^{- 1} ( \frac{( H 2 + H 3 ) \cdot cos {φ}_{x 3} + \frac{1}{2} Δ Z}{H 2 + H 3} ) \qquad Mathematical Formula 8$$
$${φ}_{x 1} + {φ}_{x 2} + {φ}_{x 3} = 0 , φ {}_{X 1}^{′} + φ {}_{X 2}^{′} + φ {}_{X 3}^{′} = 0 \qquad Mathematical Formula 9$$
$$Mathematical Formula 10$$
$$\vert ( H 1 + H 2 ) \cdot cos φ {}_{X 1}^{′} + ( H 2 + H 3 ) \cdot cos φ {}_{X 3}^{′} - Δ Z \vert < T where , φ {}_{X 1}^{′} , φ {}_{X 2}^{′} , and φ {}_{X 3}^{′}$$
are X-axis inclination angles of the first to third rotary units after correction, φ_{X1}, φ_{X2}, and φ_{X3} are current X-axis inclination angles of the first to third rotary units, H1, H2, and H3 are rotation axis lengths of the first to third rotary units, and T is a preset threshold value.

10. The control device of claim 9, wherein, in the process of correcting the coordinates of the second reference point,
when the Y-coordinate of the second reference point moves by ΔY as a preset value,
the operation includes:
calculating a generated height change ΔZ by the mathematical formulas 11 and 12,
calculating the X-axis inclination angles of the first to third rotary units by the mathematical formulas 11 to 12, and repeatedly performing the calculation until the calculated X-axis inclination angles of the first to third rotary units satisfies the mathematical formula 12,
inputting finally calculated X-axis inclination angles of the first to third rotary units into the mathematical formula 1 to calculate the rotation angles of the first to sixth wheels, and
rotating at least one of the first to sixth wheels by the calculated rotation angles to correct the Y-coordinate of the second reference point:
$$φ {}_{Y 1}^{′} = {sin}^{- 1} ( \frac{H \cdot sin {φ}_{Y 1} + \frac{1}{2} Δ Y}{H} ) = φ {}_{Y 3}^{′} = {sin}^{- 1} ( \frac{H \cdot sin {φ}_{Y 3} + \frac{1}{2} Δ Y}{H} ) \qquad Mathematical Formula 16$$
$$Mathematical Formula 17$$
$$Δ Z = ( H 1 + H 2 ) \cdot ( cos {φ}_{X 1} \cdot cos {φ}_{Y 1} ) + ( H 2 + H 3 ) \cdot ( cos {φ}_{X 3} \cdot cos {φ}_{Y 3} ) - ( H 1 + H 2 ) \cdot ( cos {φ}_{X 1} \cdot cos φ {}_{Y 1}^{′} ) + ( H 2 + H 3 ) \cdot ( cos {φ}_{X 3} \cdot cos φ {}_{Y 3}^{′} ) where , φ {}_{Y 1}^{′} and φ {}_{Y 3}^{′}$$
are Y-axis inclination angles of the first and third rotary units after correction, φ_{X1}, φ_{X3}, and φ_{X3} are current X-axis inclination angles of the first to third rotary units, φ_{Y1} and φ_{Y3} are current Y-axis inclination angles of the first and third rotary units, H1, H2, and H3 are rotation axis lengths of the first to third rotary units, and T is a preset threshold value.

11. The control device of claim 1, wherein the first rotary unit includes a first base plate disposed outside the base surface of the first wheel, and a second base plate disposed outside the base surface of the second wheel,
the second rotary unit includes a third base plate disposed outside the base surface of the third wheel, and a fourth base plate disposed outside the base surface of the fourth wheel, and
the third rotary unit includes a fifth base plate disposed outside the base surface of the fifth wheel, and a sixth base plate disposed outside the base surface of the sixth wheel.

12. The control device of claim 11, wherein the first to sixth base plates are fixed with respect to a rotation direction, and
the driving unit includes a first driving motor provided on the first base plate, a second driving motor provided on the second base plate, a third driving motor provided on the third base plate, a fourth driving motor provided on the fourth base plate, a fifth driving motor provided on the fifth base plate, and a sixth driving motor provided on the sixth base plate, such that the first to sixth wheels rotate with respect to the first to sixth base plates.

13. The control device of claim 12, wherein the driving unit includes a first driving shaft connected to the first driving motor to rotate the first wheel, a second driving shaft connected to the second driving motor to rotate the second wheel, a third driving shaft connected to the third driving motor to rotate the third wheel, a fourth driving shaft connected to the fourth driving motor to rotate the fourth wheel, a fifth driving shaft connected to the fifth driving motor to rotate the fifth wheel, and a sixth driving shaft connected to the sixth driving motor to rotate the sixth wheel.

14. The control device of claim 13, wherein the first rotary unit, the second rotary unit, and the third rotary unit are in surface contact with each other, and
the operation includes rotating a plurality of wheels among the first to sixth wheels, to adjust a position of the sixth base plate relative to the first base plate, without adjusting an inclination angle of the sixth base plate relative to the first base plate.

15. The control device of claim 13, wherein the operation includes rotating at least one wheel among the first to sixth wheels, to adjust an inclination angle of the sixth base plate relative to the first base plate, without adjusting a position of the sixth base plate relative to the first base plate.
